(19) United States
(12) Patent Application Publication
(10) Pub. No.: US 2013/0061122 A1
(43) Pub. Date: Mar. 7, 2013

(54) MULTI-CELL SELECTION USING TOUCH INPUT

(71) Applicants: Manish Sethi, Hyderabad-IDC (IN); Rajat Bhargav, Hyderabad-IDC (IN)

(72) Inventors: Manish Sethi, Hyderabad-IDC (IN); Rajat Bhargav, Hyderabad-IDC (IN)

(73) Assignee: MICROSOFT CORPORATION, Redmond, WA (US)

(21) Appl. No.: 13/227,134

(22) Filed: Sep. 7, 2011

(51) Int. Cl. G06F 17/11; G06F 17/00

(52) U.S. Cl. 715/217; 715/212; 715/219

(57) ABSTRACT

Touch input is used for multi-selection of cells within a spreadsheet. For example, a user may drag a finger across the cells of the spreadsheet that they would like to select. The multi-selection of cells may include cells within one or more rows and one or more columns of the spreadsheet. The multi-selection may be adjusted to select more or fewer cells within the multi-selection. The multi-selection of cells may be used for different purposes. For example, the cells within the multi-selection may be used to display summary information related to the multi-selection (e.g. sum, average, median, min, max, count, and the like). The multi-selection may also be used to provide input to a formula that is currently being edited (e.g. a range of cells).

### BACKGROUND

Computer display devices have been configured to function both as an input device and as a video output device. For example, computer display devices can be configured with touch surfaces that allow users to enter user input data. Sensors can detect when one or more objects contact a particular location on the display surface. A computer system can then perform some action in response to detecting the contact. For example, in response to detecting contact between an object and a display surface at a location corresponding to user-interface control, a computer system can perform some action associated with the user-interface control.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Touch input is used for multi-selection of cells within a spreadsheet. For example, a user may drag a finger across the cells of the spreadsheet that they would like to select. The multi-selection of cells may include cells within one or more rows and one or more columns of the spreadsheet. The multi-selection may be adjusted to select more or fewer cells within the multi-selection. The multi-selection of cells may be used for different purposes. For example, the cells within the multi-selection may be used to display summary information related to the multi-selection (e.g. sum, average, median, min, max, count, and the like). The multi-selection may also be used to provide input to a formula that is currently being edited (e.g. a range of cells).

### BRIEF DESCRIPTION OF THE DRAWINGS

FIG. 1 illustrates an exemplary computing device;

FIG. 2 illustrates an exemplary touch input system;

FIG. 3 shows the multi-selection of cells of a spreadsheet;

FIG. 4 shows the expansion of a current multi-selection of cells of a spreadsheet;

FIG. 5 illustrates a display of summary information related to a current multi-selection of cells of a spreadsheet;

FIG. 6 shows a process for the multi-selection of cells of a spreadsheet using a touch interface; and

FIG. 7 shows a process for displaying summary information relating to the multi-selection of cells of a spreadsheet using a touch interface.

### DETAILED DESCRIPTION

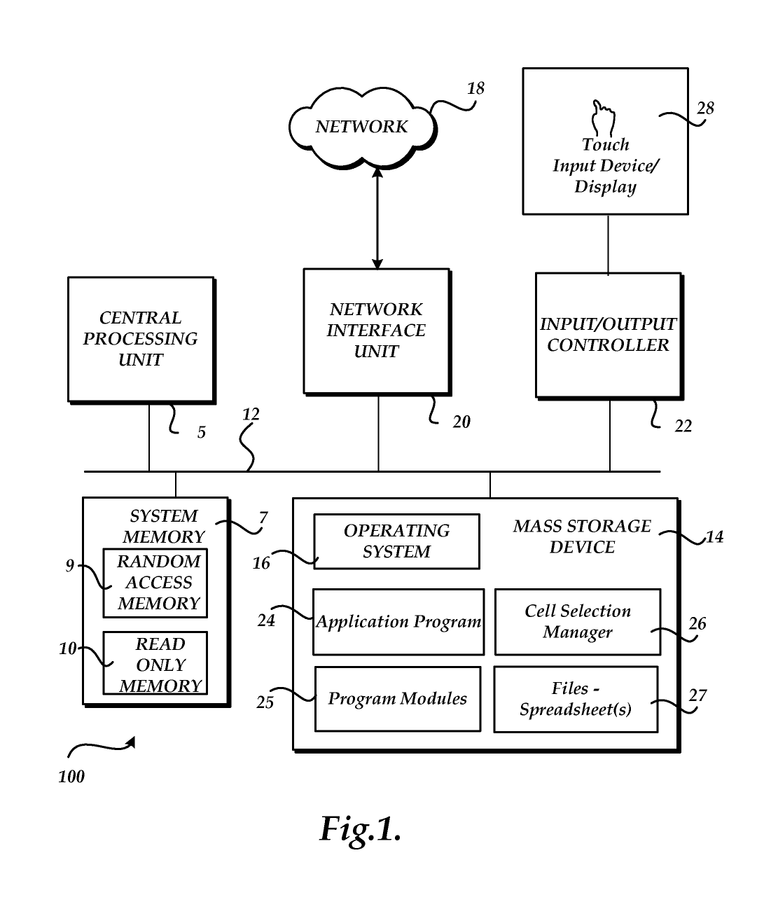

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a mobile computing device (e.g. smartphone, notebook, tablet . . . ) or desktop computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, and other program modules 25, files 27 (e.g. spreadsheets) and cell selection manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a touch input device 28. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device 28 may also act as a display. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a networked personal computer, such as the WINDOWS 7® operating system from MICROSOFT CORPORATION of Redmond, Wash. According to one embodiment, the operating system is configured to include support for touch input device 23. According to another embodiment, a cell selection manager 26 may be utilized to process some/all of the touch input that is received from touch input device 28.

The mass storage device 14 and RAM 9 may also store one or more program modules. In particular, the mass storage device 14 and the RAM 9 may store one or more application programs 24, such as a spreadsheet application. In conjunction with the operation of the application, cell selection manager 26 is used to determine and process multi-selection of cells within a spreadsheet. Generally, cell selection manager 26 is configured to process touch input that is used for multi-selection of cells within a spreadsheet. For example, a user may select a cell and then drag a finger over the display of the spreadsheet to select other cells. The multi-selection of cells may include cells within one or more rows and one or more columns of the spreadsheet. According to an embodiment, a user may create an initial selection of cells and then adjust the initial selection to include fewer or more cells. The multi-selection of cells may be used for different purposes. For example, the cells within the multi-selection may be used to display summary information related to the multi-selection (e.g. sum, average, median, min, max, count, and the like). The summary information may be predefined and/or defined by a user. The multi-selection may also be used to provide input to a formula that is currently being edited. For example, a user may select a range of cells that are used as an argument to a formula currently being edited.

Additional details regarding the operation of cell selection manager 26 will be provided below.

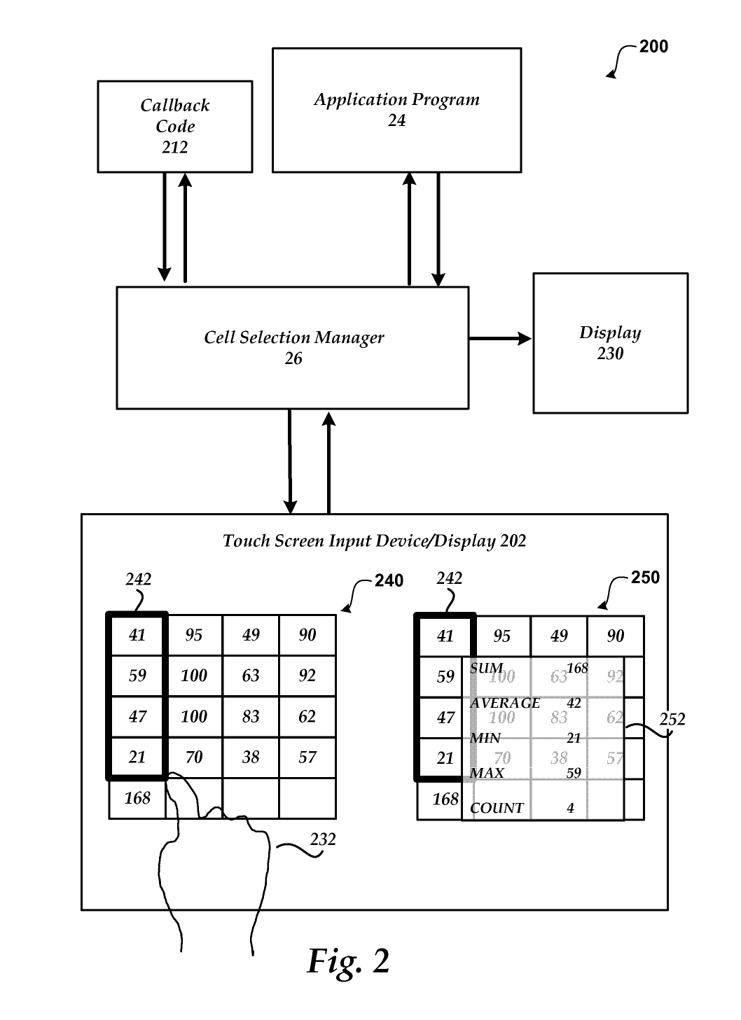

FIG. 2 illustrates an exemplary touch input system. As illustrated, system 200 includes application program 24, callback code 212, cell selection manager 26, display 230, and touch screen input device/display 202.

In order to facilitate communication with the cell selection manager 26, one or more callback routines, illustrated in FIG. 2 as callback code 212 may be implemented. According to one embodiment, application program 24 is a spreadsheet application that is configured to receive input from a touch-sensitive input device 202. For example, cell selection manager 26 may provide information to application 24 in response to a user's finger (i.e. finger on hand 232) swipes across cells of a spreadsheet.

Touch input system 200 as illustrated comprises a touch screen input device 202 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

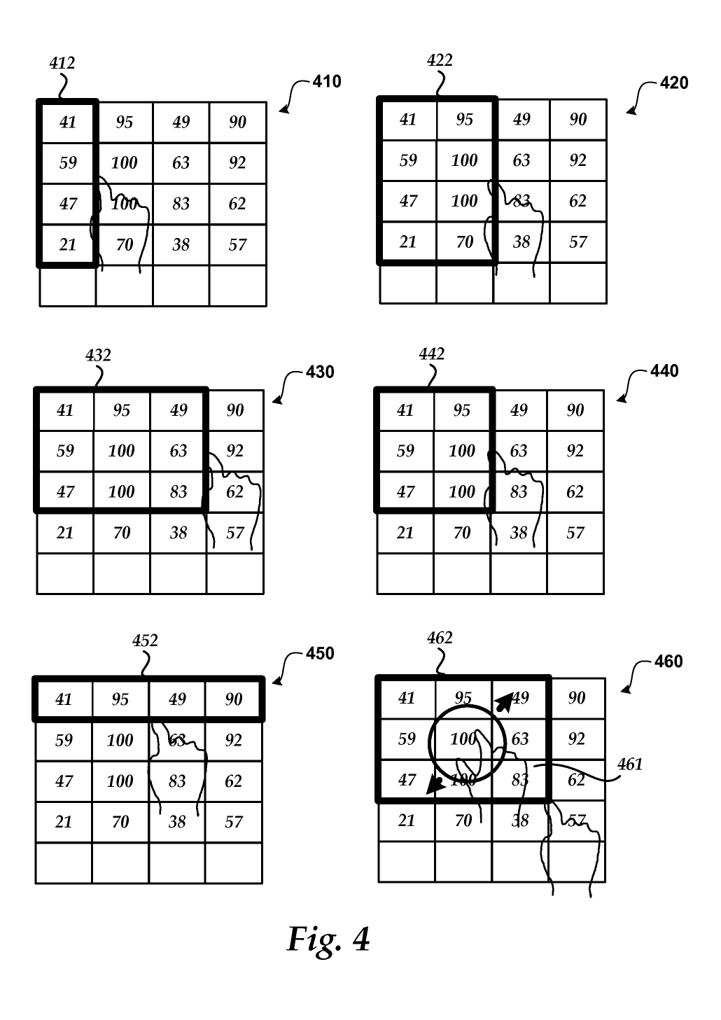

Cell selection manager 26 is configured to process the received touch input from touch screen 202. For example, a user may select a cell within a spreadsheet 240 and then drag a finger over the display of the spreadsheet to select other cells. In the current example, a user has used their hand 232 to select cells 242. According to an embodiment, a user may create an initial selection of cells and then adjust the initial selection to include fewer or more cells. The multi-selection of cells may be used for different purposes. For example, the cells within the multi-selection may be used to display summary information 252 as shown in updated spreadsheet 250 related to the multi-selection (e.g. sum, average, median, min, max, count, and the like). According to an embodiment, the summary information 252 is displayed alpha blended such that content beneath the display of the summary information remains visible. The summary information may be predefined and/or defined by a user. The multi-selection may also be used to provide input to a formula that is currently being edited. For example, a user may select the range of cells 242 such that the range is used as an argument to a spreadsheet formula currently being edited. The selected cells are based on the cells that are located from an initially selected cell to a final cell in any direction within the spreadsheet. In the current example, a user may have initially selected the top cell containing the value 41 and ended on the cell containing the value 21. According to an embodiment, a multi-selection of cells may be adjusted to include fewer/more cells through touch input (See FIG. 4 and related discussion). More details are provided below.

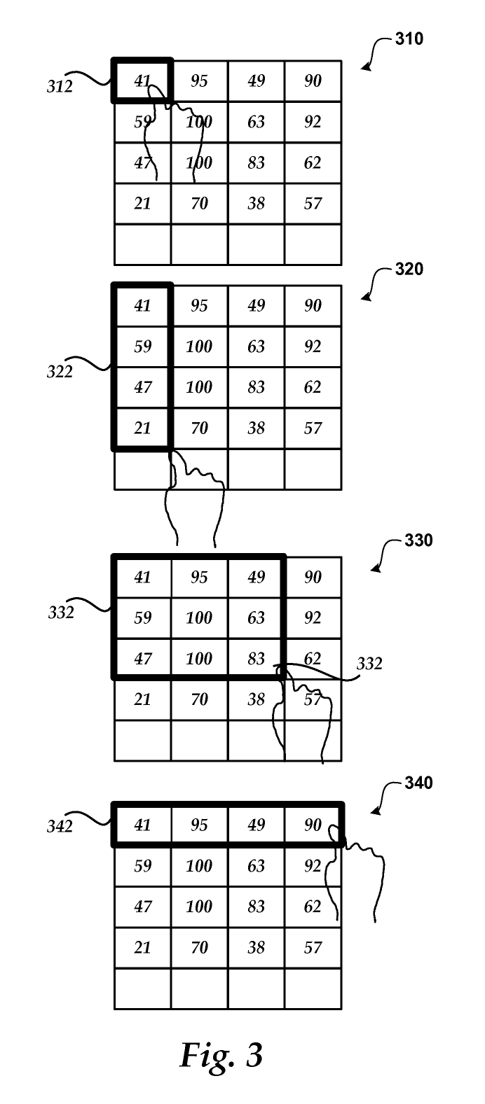

FIG. 3 shows the multi-selection of cells of a spreadsheet. As illustrated, FIG. 3 includes four different displays (310, 320, 330 and 340) that illustrate different selections within the spreadsheet. The displays may be shown on a mobile device having a limited display size (e.g. a cell phone having a display of approximately 2 by 3 inches, a tablet having approximately a 7-10 inch display, and/or other devices having other display sizes). The displays may also be shown on a touch screen.

Display 310 shows an initial selection of a cell. According to an embodiment, a user first selects a cell that is used as a starting point for the multi-selection of cells. In the current example, the user has selected cell 312 using one of their fingers that includes the value 41.

Display 320 shows the user selecting a column of cells 322 by dragging their finger down display 320. The dragging of the finger may occur immediately after selecting cell 312 or at some time after selection of cell 312. For example, a user may place their finger on cell 312 and then without lifting their finger off of the display drag their finger down until the user has selected the desired number of cells. A graphical indicator may be used to distinguish the currently selected cells. As illustrated, a border around the selected cells is displayed to indicate the current selection of cells. According to an embodiment, any portion of the border may be selected to move an edge of the border. Other graphical indicators may also be used. For example, a coloring/shading of the selected cells may be used to differentiate the current selected cells. Once the user has selected the desired cells, they may move their finger off of the touch screen such that it is not detected.

Display 330 shows the user selecting a portion of cells from three rows and three columns of a spreadsheet. The user may select the group of cells using different techniques. For example, the user may move his finger diagonally from cell 312 to cell 332. The user may move horizontally and then vertically down to cell 332. The user may more vertically down and then horizontally to cell 332. According to an embodiment, the selection is based on the cells between the starting cell and the ending cell (e.g. the cell where the touch input is no longer detected).

Display 340 shows the user selecting a column of cells 342 by dragging their finger horizontally across display 340.

FIG. 4 shows the expansion of a current multi-selection of cells of a spreadsheet. As illustrated, FIG. 4 includes three displays (410, 430, 450) that illustrate an initial selection of a group of cells within the spreadsheet and three displays (420, 440, 460) that illustrate updated selection of cells.

Display 410 shows an initial selection of a group of cells 412. In the current example, the user has selected a row of cells 412. While selected the user may decide to expand/reduce the number of cells selected. According to an embodiment, the user may place their finger anywhere within the currently selected cells to make a change to the currently selected cells.

Display 420 shows the user expanding the selection of cells 412 by dragging their finger across the display to select an additional column of cells 422.

Display 430 shows an initial selection of cells 432 from three rows and three columns of a spreadsheet.

Display 440 shows the user changing the initial selection of cells 432 to include fewer cells. As illustrated, a user has moved their finger toward the left of display 440 to reduce the selection of cells 442.

Display 450 shows an initial selection of a row of cells 450 from a column of a spreadsheet.

Display 460 shows the user changing the initial selection of cells 442 to include fewer cells within the initially selected row but more columns. As illustrated, a user has moved their finger toward the left of display 460 and downward to create to the selection of cells 462. A user may also perform some other gesture to change a size of the initial selection of cells. For example, a user may spread their fingers apart to change a size of the multi-selection.

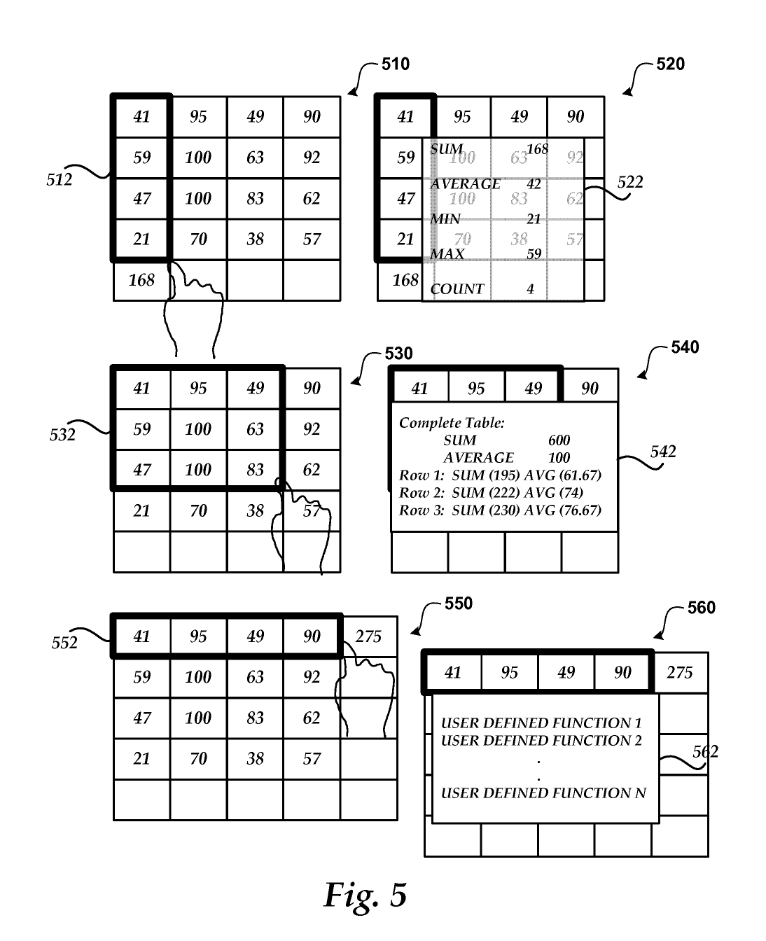

FIG. 5 illustrates a display of summary information related to a current multi-selection of cells of a spreadsheet. As illustrated, FIG. 5 includes three displays (510, 530, 550) that illustrate an initial selection of a group of cells within the spreadsheet and three displays (520, 540, 560) that each illustrate a summary (522 displayed as an alpha blend, 542, 562) related to a current selection (512, 532, 552). Generally, the summary information displays a quick view of different statistical information of the data currently selected, obviating the need to modify the spreadsheet with these values if the user is just reviewing the data on the spreadsheet.

Display 510 shows an initial selection 512 of a group of cells. Display 520 shows an display of summary information 522 that displays information relating to the current selection of cells. As illustrated, summary information 522 shows a sum, average, a minimum value, a maximum value and a count that are calculated using values that are contained within the current selection of cells. The display of the summary information may occur automatically/manually. For example, the summary may be displayed in response to a manual selection of a menu option and/or automatically after the selection is made. The summary information may be removed from the display in response to different actions. For example, a user may select a menu option to remove the display, select an area outside of the summary information, select an option within the display of the summary information, and/or automatically being removed from the display after a predetermined period of time has elapsed (e.g. 5, 10, 15, 20, 25 seconds). According to an embodiment, one or more of the displayed functions (e.g. sum, average, min, max, count) are selectable using the touch interface. Upon selection, different actions may occur. For example, more information may be shown relating to the selected function, the function may be added to a cell within the spreadsheet, the display of the summary information may be removed from the display, and the like.

Display 530 shows an initial selection 532 of a group of cells. Display 540 shows an display of summary information 542 that displays summary information relating to the current selection of cells. As illustrated, summary information 542 shows a sum and average for all of the values from the selection and sum and average values for each row within the selection. Many types of functions may be applied to the data and formatted in different manners. According to an embodiment, the options are configurable by a user. For example, a user may define and/or select from different options that may be shown within a summary information display.

Display 550 shows an initial selection 552 of a group of cells. Display 560 shows an display of summary information 562 that displays summary information relating to the current selection of cells. As illustrated, summary information 562 shows that a user may define the functions that are applied to the data that is currently selected within the cells. The user-defined functions may be selected from a default set of functions (e.g. sum, average, min, max, count, and the like) and/or may be defined by a user. For example, a user may create formulas that are applied to the data.

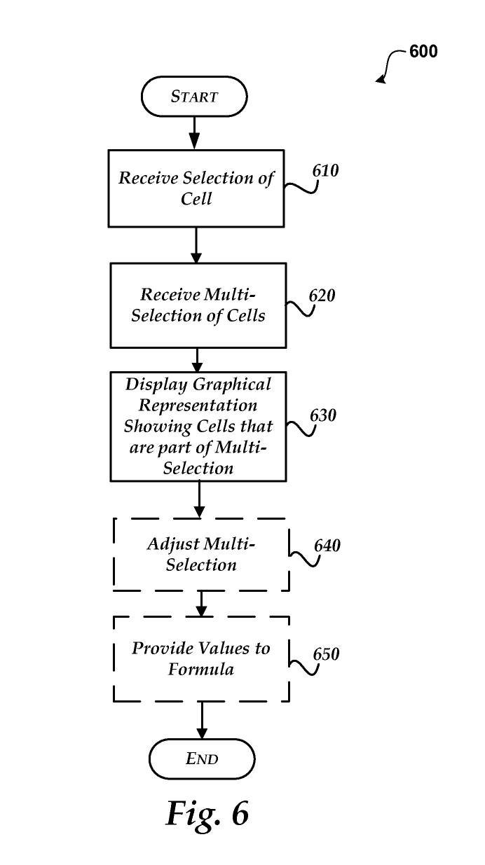

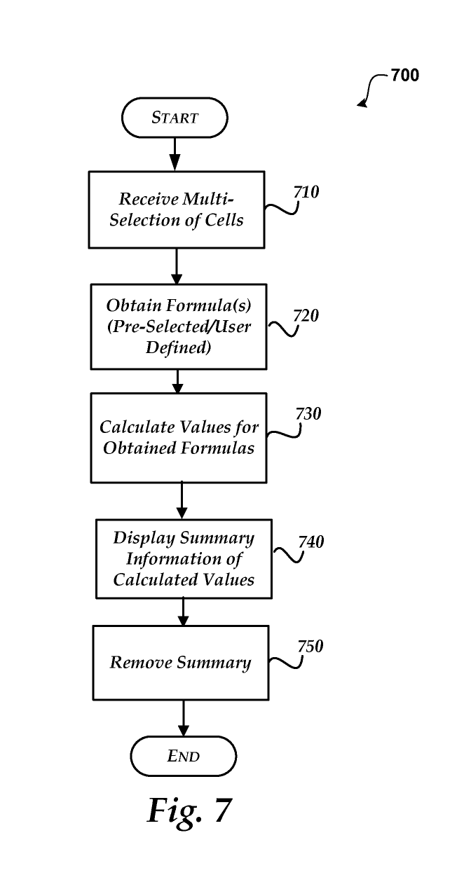

Referring now to FIGS. 6-7, illustrative processes 600 and 700 are shown relating to multi-selection of cells and display of summary information will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 6 shows a process 600 for the multi-selection of cells of a spreadsheet using a touch interface.

After a start operation, the process flows to operation 610, where a touch input is received indicating a selection of a cell. According to one embodiment, the user places at least a portion of a finger on the touch surface to select a cell. A cell is selected in response to the user touching the display of the cell. According to an embodiment, a cell is selected based on touch detection detected within a virtual size of the cell (e.g. if a finger is within a predetermined tolerance of a size of the cell). For example, even if the user's finger is detected slightly below the bottom border of the cell, the cell above the actual selection may be selected. Additionally, according to some embodiments, the user may only have to place their finger (or some other object) near the surface of the touch surface for touch input to be received and detected.

Moving to operation 620, a multi-selection of cells is received. The multi-selection of cells may include cells within one or more rows and one or more columns of the spreadsheet. According to an embodiment, the multi-selection of the cells may occur in continuation with the touch input received for the initial selection of a cell and/or at a later point in time. For example, a tap may be initially received to select a cell and then a separate drag input from the cell to other cells may be used to include fewer or more cells. Once the user has selected the desired cells, they may move their finger off of the touch screen such that it is not detected.

Flowing to operation 630, a graphical representation of the cells that are selected are displayed. A graphical indicator may be used to distinguish the currently selected cells. For example, a border around the selected cells is displayed to indicate the current selection of cells. Other graphical indicators may also be used. For example, a coloring/shading of the selected cells may be used to differentiate the current selected cells.

Transitioning to operation 640, the current selection of cells may be adjusted if desired. As discussed above, a user may adjust the current selection of cells to include fewer or more cells. According to an embodiment, a user may select anywhere within/on/near the border (actual, virtual) of the current selection to adjust its size. The border that is closest to the touch input is selected to be adjusted. For example, if a user touches near a right border then the right border is adjusted to change a size. A corner of the border may also be selected.

Moving to operation 650, information relating to the current selection of cells (e.g. values, cell locations) may be provided to one or more formulas that are associated with the spreadsheet. For example, the range of cells may be provided to a formula, the values within the cells may be used within one or more formulas and the like.

The process then flows to an end operation and returns to processing other actions.

FIG. 7 shows a process 700 for displaying summary information relating to the multi-selection of cells of a spreadsheet using a touch interface.

After a start operation, the process flows to operation 710, where the multi-selection of cells is determined.

Moving to operation 720, the formulas to apply to the data associated with the currently selected cells is determined. The formulas may be predefined and/or configured by a user. For example, according to an embodiment, when an auto sum function is selected, summary information for the current selection automatically shows a sum, average, min, max, and count for the currently selected cells. A user may also configured their own functions and/or set the values that are displayed within the summary information.

Flowing to operation 730, the formulas are used to calculate the summary information to be displayed.

Transitioning to operation 740, the summary information is displayed for the currently selected cells. As discussed above, the summary information may be automatically/manually displayed.

Moving to operation 750, the summary information display is removed from the display. The summary information may be removed in response to a user action (e.g. selecting a menu option, selecting a different part of the screen) and/or automatically.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for selecting cells of a spreadsheet, comprising:
determining a selection of an initial cell made using a touch input device within a display of the spreadsheet;
determining a multi-cell selection of cells of the spreadsheet using the touch input device that includes the initial cell and an ending cell of the touch input;
displaying a graphical representation indicating the multi-cell selection on a display that is associated with the touch input device; and
automatically incorporating information obtained from the multi-selection into a formula that is associated with the spreadsheet.

2. The method of claim 1, further comprising receiving touch input that starts at any location within a border of the multi-selection to adjust a size of a border of the multi-cell selection to include a different number of cells.

3. The method of claim 1, wherein displaying the graphical representation indicating the multi-cell selection on the display comprises displaying a border around the multi-selection of cells.

4. The method of claim 1, further comprising automatically incorporating values obtained from cells of the multi-cell selection into an auto sum formula that is associated with the spreadsheet that adds all of the values of the cells within the multi-selection.

5. The method of claim 1, further comprising automatically calculating summary information comprising a sum, an average, a min, a max and a count from values obtained from cells of the multi-cell selection and displaying the calculated values on the display without incorporating the calculated values within the spreadsheet.

6. The method of claim 1, further comprising automatically displaying summary information calculated from values obtained from cells of the multi-cell selection.

7. The method of claim 6, further comprising automatically removing the display of the summary information.

8. The method of claim 1, wherein the multi-cell selection includes cells that are hidden within a view of the spreadsheet.

9. The method of claim 1, further comprising automatically displaying summary information calculated from values obtained from cells of the multi-cell selection and based on user-defined formulas.

10. A computer-readable medium having computer-executable instructions for selecting cells of a spreadsheet using touch input, comprising:
determining a multi-cell selection of cells of the spreadsheet using the touch input device;
displaying a graphical representation indicating the multi-cell selection on a display that is associated with the touch input device; and
automatically incorporating information obtained from the multi-selection into a formula that is associated with the spreadsheet.

11. The computer-readable medium of claim 10, further comprising receiving touch input after the multi-selection to adjust a size of the multi-selection of cells to include a different number of cells.

12. The computer-readable medium of claim 10, further comprising automatically incorporating values obtained from cells of the multi-cell selection into an auto sum formula that is associated with the spreadsheet that adds each of the values of the cells within the multi-selection.

13. The computer-readable medium of claim 10, further comprising automatically calculating summary information comprising a sum and an average from each of the values obtained from cells of the multi-cell selection and displaying the summary information on the display without incorporating the calculated values within the spreadsheet.

14. The computer-readable medium of claim 10, further comprising automatically displaying summary information calculated from values obtained from cells of the multi-cell selection.

15. The computer-readable medium of claim 14, further comprising receiving a selection of an item presented in the summary information and associating the selection with a cell within the spreadsheet.

16. The computer-readable medium of claim 10, wherein the multi-cell selection includes cells that are hidden within a view of the spreadsheet when selected.

17. The computer-readable medium of claim 10, further comprising automatically displaying summary information calculated from values obtained from cells of the multi-cell selection and based on user-defined formulas.

18. A system for utilizing a virtual input device created in response to touch inputs, comprising:
a display;
a touch surface that is configured to receive touch input;
a processor and a computer-readable medium;
an operating environment stored on the computer-readable medium and executing on the processor; and
a cell selection manager operating under the control of the operating environment and operative to:
determine a multi-cell selection of cells of the spreadsheet using the touch input device;
display a graphical representation indicating the multi-cell selection on a display that is associated with the touch input device; and
automatically incorporate information obtained from the multi-selection into a formula that is associated with the spreadsheet.

19. The system of claim 18, further comprising automatically calculating summary information comprising a sum and an average from each of the values obtained from cells of the multi-cell selection and displaying the summary information on the display without incorporating the calculated values within the spreadsheet.

20. The system of claim 18, further comprising automatically displaying summary information calculated from values obtained from cells of the multi-cell selection and based on user-defined formulas.
